(19) United States
(12) Patent Application Publication
(10) Pub. No.: US 2014/0358758 A1
(43) Pub. Date: Dec. 4, 2014

(54) SYSTEMS AND METHODS FOR AUTOMATED MANAGEMENT OF STANDARD CAPACITY PRODUCT AND CAPACITY PLANNING MANAGEMENT

(71) Applicant: GRIDSPEAK CORPORATION, Oakland, CA (US)

(72) Inventor: Karl A. Simmons, Oakland, CA (US)

(73) Assignee: GRIDSPEAK CORPORATION, Oakland, CA (US)

(21) Appl. No.: 14/272,437

(22) Filed: May 7, 2014

Related U.S. Application Data
(63) Continuation of application No. PCT/US2012/063969, filed on Nov. 7, 2012.
(60) Provisional application No. 61/556,748, filed on Nov. 7, 2011.

(51) Int. Cl. G06Q 40/04; G06Q 50/06

(52) U.S. Cl. CPC G06Q 40/04; G06Q 50/06
USPC 705/37

(57) ABSTRACT

Systems and methods are provided for instantly and electronically calculating estimated performance incentives and non-availability charges for Standard Capacity Product (SCP) and automating selling, buying and trading capacity to meet electricity market Resource Adequacy (RA) requirements. More specifically, the invention relates to systems and methods for instantly and electronically calculating estimated performance incentives and non-availability charges for SCP and automating selling, buying and trading capacity to meet electricity market RA requirements on a mobile device, or web interface.

### CROSS-REFERENCE

This application is a continuation application of PCT Application No. PCT/US2012/063969, filed on Nov. 7, 2012, which claims priority to U.S. Provisional Application No. 61/556,748, filed Nov. 7, 2011, each of which application is incorporated herein by reference in its entirety.

### BACKGROUND OF THE INVENTION

Resource Adequacy (RA) policy frameworks have been adopted primarily in deregulated electricity markets in order to ensure reliability of electric service by providing sufficient resources to a grid operator to ensure safe and reliable operation of the grid in real time and by providing appropriate incentives for siting and construction of new resources needed for reliability in the future.

Such frameworks may establish RA obligations applicable to Load Serving Entities (LSEs) such as investor owned utilities (IOUs), energy service providers (ESPs) and community choice aggregators (CCAs). The framework may guide resource procurement and promote infrastructure investment by requiring that LSEs procure capacity so that capacity is available when and where needed. Each LSE may be required to file documentation on a periodic basis demonstrating that it has procured sufficient capacity resources including reserves needed to serve its aggregate system load. Further, rules may be provided for “counting” resources toward meeting RA obligations. The resources that are counted for RA purposes must make themselves available for the capacity for which they were counted. LSEs acquire the right to claim the contracted power as RA capacity in their compliance filings upon generators' commitment to make such capacity available. In such a scheme, generators' performance obligations, associated remedies, and appropriate level of compensation for taking on such obligations must be clearly determined in order to make RA capacity a liquid, tradable product.

Wholesale electricity market operators have introduced a financial product called Standard Capacity Product (SCP) intended to simplify and increase the efficiency of RA programs. This product establishes a standard product definition for RA capacity, facilitates selling, buying, and trading capacity to meet RA requirements, defines periodic (e.g. annual and monthly) availability standards, creates a standard method for evaluating performance from RA resources and creates performance incentives and non-availability charges. This effectively reduces contracting between an LSE and a generator to the sale of a right of the holder to claim such capacity in its compliance while at the same time such capacity, once committed, becomes subject to performance commitments and associated remedies. More direct and effective enforcement of the generator's performance obligations is intended to simplify RA contracting.

However, the settlement period for the performance incentives and non-availability charges extends beyond the period for risk mitigation. This issue has created a problem where resources exposed to non-availability charges are not able to mitigate these charges before the end of market settlement because of the delay of settlement information.

Therefore, a need exists for improved systems and methods for automated management of standard capacity product and capacity planning to provide risk mitigation paths for resources before the close of the settlement period. A further need exists for systems and methods for electronic automated management of standard capacity product and capacity planning through an interface.

### SUMMARY OF THE INVENTION

The invention relates to systems and methods for instantly and electronically calculating estimated performance incentives and non-availability charges for Standard Capacity Product (SCP) and automating selling, buying and trading capacity to meet electricity market Resource Adequacy (RA) requirements. More specifically, the invention relates to systems and methods for instantly and electronically calculating estimated performance incentives and non-availability charges for SCP and automating selling, buying and trading capacity to meet electricity market RA requirements on a mobile device, or web interface.

One aspect of the invention relates to an automated SCP/capacity planning management system comprising one or more management interfaces hosted on one or more devices with a display, wherein the one or more management interfaces are configured to accept input from one or more users via a graphical interface shown on the display; and one or more engines in communication with the one or more management interfaces over a network, wherein the one or more engines are configured to process, with the aid of one or more processors and a memory, the input from one or more users in accordance with one or more workflow rules and algorithms, and wherein the one or more engines are configured to communicate SCP/capacity planning related information with the one or more management interfaces.

A further aspect of the invention provides a method for automated SCP/capacity planning management, said method comprising providing a management system comprising one or more processors and a memory, wherein the management system is configured to store one or more SCP/capacity planning tasks within the memory; accepting, at the management system, a user request or response input and SCP/capacity planning information; and providing, from the management system, one or more SCP/capacity planning notifications or requests, wherein said notifications or requests are generated using the one or more processors of the management system based on the user request or response input and SCP/capacity planning information in accordance with one or more workflow rules.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an automated SCP/capacity planning management system in communication with a grid operator and one or more customers.

FIG. 2 shows an automated SCP/capacity planning management system.

FIG. 3 shows a plurality of devices capable of communicating with a server over a network.

### DETAILED DESCRIPTION OF THE INVENTION

While preferred embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides systems and methods for automating the SCP/capacity planning management process. Various aspects of the invention described herein may be applied to any of the particular applications set forth below or for any other types of power management system. The invention may be applied as a standalone system or method, or as part of a service, tool, or electricity management package. It shall be understood that different aspects of the invention can be appreciated individually, collectively, or in combination with each other.

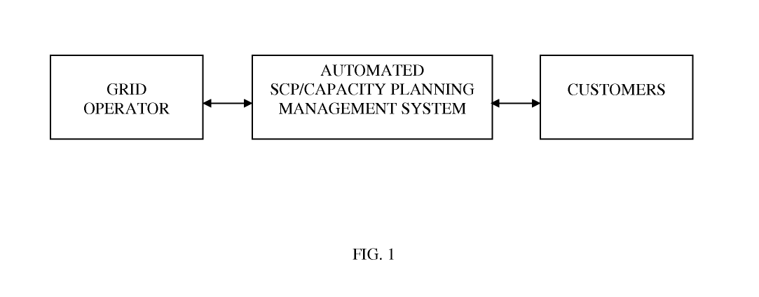

FIG. 1 shows an automated SCP/capacity planning management system. The automated SCP/capacity planning management system may receive input from a grid operator and/or one or more customers who may be interacting with one or more interfaces of the automated SCP/capacity planning management system. The one or more customers may include but are not limited to power generators, LSEs such as IOUs, ESPs and CCAs, various system resource entities, transmission owners or transmission operators, third parties such as external trading or scheduling agents, regulatory agencies, and/or other market participants such as traders or speculators. These entities may interact with the system as customers and/or may interact with the system in other ways described herein. Furthermore, one or more of these entities may interact with the system by proxy. For example, a transmission owner/operator may report transmission line outages to a grid operator rather than having direct access to the system as a customer.

Inputs from parties interacting with the system, either directly or by proxy and including grid operators and customers, herein collectively referred to as system participants or users, may include status and information requests regarding capacity distribution and allocation, prices and electricity market metrics, input of capacity generation/demand, scheduling input, bids to buy, sell or trade capacity and response/mitigation of system requests. The automated SCP/capacity planning management system may automatically process the inputs in accordance with one or more sets of rules. The rules may be predetermined.

The automated SCP/capacity planning management system may automatically receive input from a system participant and send requests and/or updates to one or more system participants according to a set of predetermined rules without requiring user interaction. The predetermined rules may include determining availability, RA and other capacity supply and demand, resource performance metrics and other capacity metrics. The SCP/capacity planning management system may accept a user input that may be incorporated into processing of another input. In some embodiments, the automated management system may accept a user input that may alter the predetermined rules.

Based on the processing, the automated SCP/capacity planning management system may update system status and provide information and/or requests to system participants. For example, the automated SCP/capacity planning management system may receive a bid to sell RA capacity from a generator, evaluate the bid according to electricity market RA requirements and/or capacity metrics, match the bid to sell with a bid to buy said RA capacity, request input from an LSE to confirm the transaction, update the transaction to the system and notify all parties of its completion. In another example, the system may calculate financial incentives or charges for SCP based on real-time system inputs and/or predictions and instantly notify one or more generators of associated opportunities or risks. In yet another example, the system may evaluate SCP for RA resources interacting with the system and may provide dynamic scheduling and re-scheduling of RA resources to meet electricity market RA requirements.

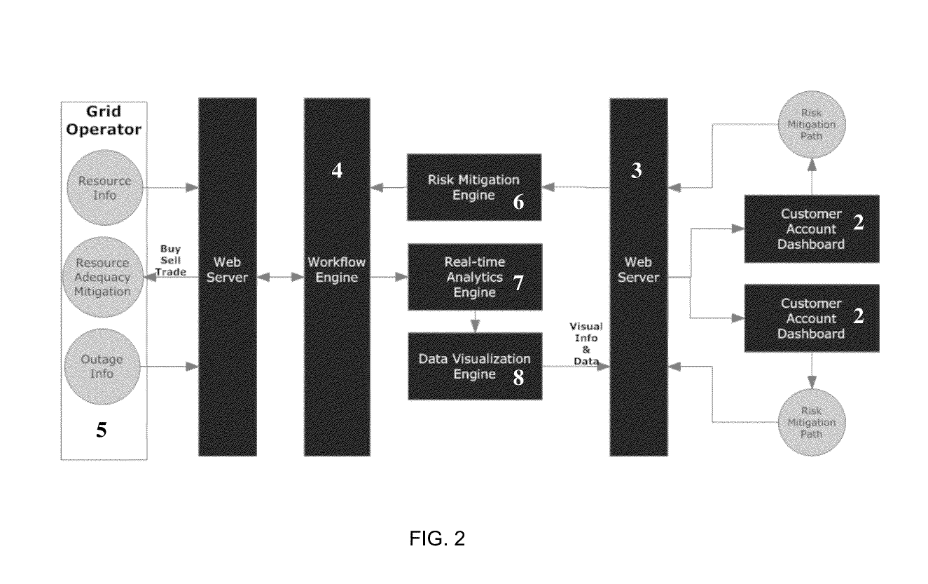

FIG. 2 illustrates an automated SCP/capacity planning management system in accordance with an embodiment of the invention. The automated SCP/capacity planning management system may comprise a workflow engine 4. The workflow engine or system (or portions thereof) may communicate electronically with a grid operator system 5 via one or more web servers 1. The grid operator 5 may or may not have a separate management interface (not shown). The workflow engine or system (or portions thereof) may further communicate electronically with a risk mitigation engine 6 and a real-time analytics engine 7, which may be in further communication with a data visualization engine 8. The risk mitigation engine 6 and data visualization engine 8 may communicate electronically with one or more management interfaces or customer account dashboards 2 via one or more web servers 3. The one or more management interfaces may communicate with and/or reside on the one of more web servers. In some embodiments, one or more web or mobile interfaces for operations may be provided to the grid operator, customers and/or other system participants. For example, the one or more customer account dashboards 2 may be supplemented or replaced by one or more web or mobile interfaces.

The workflow engine 4 may serve as the central workflow facility managing the inputs, outputs, processing, scheduling and transactions of the system. Preferably, processing involving calculations, analysis and logic may reside separately in the real-time analytics engine 7 and may interact with the workflow engine 4. Such analytics may include optimization and/or other algorithms. Alternatively, the functionality of the real-time analytics engine 7 could reside within the workflow engine 4, within the engines 6, 8, on the one or more servers 1, 3 and/or on one or more other devices that may be part of or in communication with the system as described elsewhere herein.

Further, data visualization may reside in a data visualization engine 8. In such a configuration, the data visualization engine 8 may be aimed at providing visual representation of processes and workflow in the automated SCP/capacity planning management to the one or more customers. The data visualization engine 8 may or may not also be aimed at providing visual representation of processes and workflow in the automated SCP/capacity planning management to the grid operator. The grid operator system 5 may or may not have a separate data visualization engine within. In some embodiments, data visualization may reside elsewhere in the system, such as, for example, within the workflow engine 4. Alternatively, data visualization may reside in two or more data visualization engines 8. For example, a first data visualization engine may interact with the workflow engine on the grid operator side and a second data visualization engine may interact with the workflow engine on the customer side. Data visualization may include the workflow tools described herein.

A risk mitigation engine 6 comprising processing and analysis of risk mitigation paths for resources may also be in communication with the workflow engine 4. Alternatively, the functionality of the risk mitigation engine 6 could reside within the workflow engine 4, within the engines 7, 8, on the one or more servers 1, 3 and/or on one or more other devices that may be part of or in communication with the system as described elsewhere herein.

The engines 4, 6, 7, 8 may interact with user inputs and/or generate user output. Together, the engines 4, 6, 7, 8 may comprise the processing center of the automated SCP/capacity planning management, wherein the engines 6, 7, 8 may provide processing input and output to the workflow engine 4, which may be in charge of the workflow itself. Alternatively, workflow management may be distributed between the one or more engines 4, 6, 7, 8.

The web servers 1, 3 may act as electronic information transfer hubs connecting the engines 4, 6, 7, 8 with the one or more users 5, 2. In some embodiments, the web servers 1, 3 may act as processing units in their own right, as described elsewhere herein.

SCP may comprise, for example, one or more of the following: information regarding RA capacity from generators and system resources reported in supply plans, ancillary services capacity for certified products under an RA obligation, periodic availability standards calculated using the total fleet of RA resources and metrics to measure a resource's availability. Further information supplied to, processed by and/or output from the automated SCP/capacity planning management system may include one or more of the following, in no particular order: planned and real-time RA capacity supply and demand, supply plans, unit substitutions (wherein a non-RA unit may be used to substitute capacity for an RA resource during forced outages or de-rate of RA resource) from generators and system resources to meet capacity obligation for the calculation of availability metric, pre-qualification of unit substitutions, rating and qualification of RA resources, ancillary services information, capacity availability, calculation of average availability (capacity availability standard), comparison of a resource's availability against the capacity availability standard, reporting forced and planned outages, reporting de-rates, calculating non-availability charges, calculating estimated performance incentives and so on.

These various information flows and calculated metrics may be used in the automated SCP/capacity planning management system to provide risk mitigation paths for resources before the close of the market settlement period, thus providing instant and electronic notification to resources exposed to non-availability charges. Such early notification may allow resources to mitigate in time to avoid non-availability charges. In addition to notification, the automated SCP/capacity planning management system may further provide risk mitigation paths by nature of automatic processing by the system.

These various information flows and calculated metrics may also be used in the automated SCP/capacity planning management system to provide estimated performance incentives for SCP. For example, a resource facing non-availability charges may provide an opportunity for another resource to fill in the capacity gap.

The automated SCP/capacity planning management system may determine financial incentives such as non-availability charges and performance incentives through calculations based on various system inputs, outputs and processing operations. For example, a financial incentive may be determined for a resource in the case that its capacity availability exceeds the capacity availability standard. In such a case, the RA resource may receive an availability incentive payment. Conversely, a financial charge may be determined for a resource in the case that its capacity availability is less than the capacity availability standard. In such a case, the RA resource may receive a non-availability charge. Such determinations require one or more inputs and processing steps by the automated SCP/capacity planning management system. For example, these steps may comprise input from the total fleet of RA resources in the system regarding their availability, which may comprise real-time as well as periodic inputs, real-time and/or average input from the resource in question, calculation of capacity availability standard and comparison of the resource capacity availability against the capacity availability standard. Furthermore, the financial incentives or charges may depend on real-time supply, demand and transmission of capacity and as such may require input from LSEs, transmission owners/operators, other system participants and/or sensors.

Risk mitigation and incentive capture paths provided by the automated SCP/capacity planning management system in accordance with embodiments of the invention may involve calculating financial incentives and charges and implementing resource adjustments accordingly within a market settlement period as provided by the rules of individual electricity markets. Resource adjustments may involve automated/semi-automated capacity allocation/re-allocation and planning, bidding, substituting and/or purchasing capacity to meet or exceed obligations and reaching settlements. Furthermore, information flows associated with risk mitigation may be incorporated in bookkeeping and monitoring of the state of the electricity market by the automated SCP/capacity planning management system.

Additionally, the automated SCP/capacity planning management system of FIG. 2 may allow for selling, buying and trading capacity to meet electricity market RA requirements. Energy may be bid and scheduled to meet capacity demand by way of bidding and scheduling of RA resources. Additionally, RA resource substitutions made to satisfy adequacy requirements and maintain SCP rating, as well as transactions to profit from financial incentives and/or avoid financial charges as described elsewhere herein may also be provided as part of this functionality. Preferably, the risk mitigation pathway management may reside in the risk mitigation engine 6, which may or may not provide risk mitigation management separately from transactions for meeting RA requirements. The risk mitigation engine 6 may provide management of exceptions to baseline RA market operations. Alternatively, the risk mitigation engine 6 may provide processing of baseline RA market operations as well as risk mitigation operations. The risk mitigation engine 6 may include optimization and/or other algorithms for optimizing risk mitigation paths based on user inputs.

A grid operator 5 may provide resource, outage and/or other information to the automated SCP/capacity planning management system via one or more web servers 1. The grid operator system 5 may comprise an electronic resource monitoring system, such as for example communications with various sensors, transmission entities, generator entities and/or load serving entities. The web server 1 may communicate electronically with the workflow engine 4, which may be the main workflow management unit of the automated SCP/capacity planning management system. The workflow engine 4 may initiate processing operations in the real-time analytics engine 7. The processing operations may be initiated in accordance with workflow rules. The processing operations in the real-time analytics engine 7 may be further processed and arranged according to the data visualization principles of the present invention in the data visualization engine 8 prior to communication to users. Visual information and data may be transferred to the one or more customers via the one or more web servers 3. The customers may view this output via one or more customer account dashboards 2, which may be mobile devices, web interfaces or the like. The one or more customers may provide active responses, automated responses or a combination of active and automated responses to said outputs. The one or more customers may also not respond to said output. Customer responses may include information and/or action requests for risk mitigation paths, bidding/scheduling of RA resources or any other SCP/capacity planning action described herein. Customer responses may be communicated back to the workflow engine 4 via the one or more web servers 3, wherein the responses may be processed in the risk mitigation engine 6 prior to further submission to the workflow engine 4. The workflow engine may schedule, approve, output or prompt information and/or tasks based on results of this processing. The workflow may take these actions based of workflow rules described herein. Results of processing and workflow operations may be communicated to the grid operator. Such results may include a request to implement buying, selling or trading of capacity on the electricity grid controlled by the grid operator for efficient RA mitigation. While the automated SCP/capacity planning management system information flows may appear to be sequential as described, the information flows may be dynamic and occur sequentially, in parallel or a mixture thereof. For example, sensor input may be continuous while a trading operation may require sequential approval of trading partners.

The workflow engine 4 may comprise administration tools for designing rules for workflow. Such tools may be used to customize workflow parameters, define checklists and define criteria for SCP/capacity planning management processes within the workflow engine 4. The tools may reside within the workflow engine, on a web server, within another engine in the system and/or on any computer or other network device in communication with these system components. Any description of workflow tools herein may also be applied to a workflow engine, in which case the workflow engine may be understood to comprise these tools. Furthermore, any user interface described herein may also assist with workflow design. The workflow tools may reside in the data visualization engine 8.

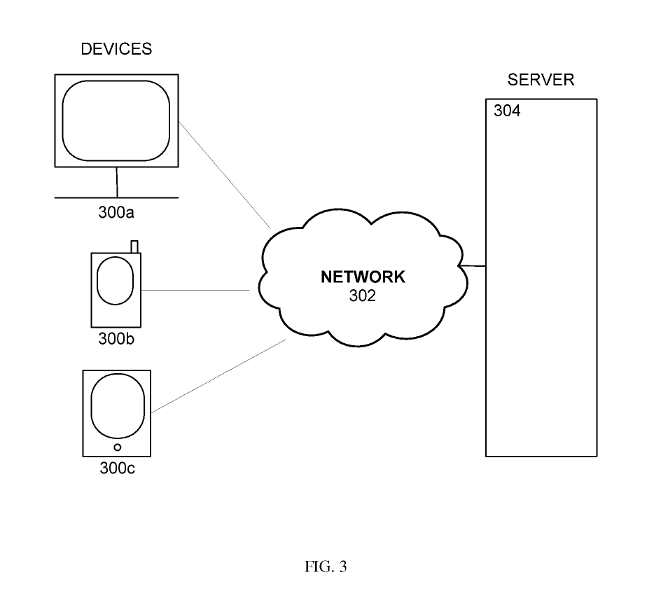

FIG. 3 shows a plurality of devices 300a, 300b, 300c capable of communicating with a server 304 over a network 302. The devices 300a, 300b, 300c may be network devices. The devices may be the same type of device and/or may include different types of devices. For example, the devices may be a computer 300a, a smartphone 300b, and/or a tablet 300c. Mobile devices may interact with the system. The devices 300a, 300b, 300c may communicate with a web server 304.

Network devices may include computers whether they be a personal computer, server computer, or laptop computer; mobile devices, such as a tablet, personal digital assistants (PDAs) such as a Palm-based device or Windows CE device; phones such as cellular phones, smartphones (e.g. iPhone, BlackBerry, Android, Treo); a wireless device such as a wireless email device or other device capable of communicating wirelessly with a computer network or other communication network; or any other type of network device that may communicate over a network and handle electronic transactions. Any discussion herein of computers or mobile devices may also be applied to any other network devices as provided.

A computer or other network device may communicate with the one or more web servers. The communication between a network device and a web server may be, for example, a connection between a client computer and a website server over a network. One or more servers may communicate with one or more computers or other network devices across a network. The network, for example, can include a private network, such as a LAN, or interconnections to the online organizations over a communications network, such as the Internet or World Wide Web or any other network that is capable of communicating digital data, such as a wireless, cellular, or telecommunications network. Each computer or other network device may connect to one or more web servers over the network using data protocols, such as HTTP, HTTPS and the like.

Generally, the workflow tools herein may provide an object-based, graphical interface modeling the individual tasks required to complete a task within the SCP/capacity planning management process. A user may interact with a server, computer, mobile device (e.g. tablet, smartphone) or other network device that may host the workflow tools. When a computer or other network device is communicating with the web server, the device may have a processor and a memory that may store an operating system (OS) and a browser application or other application to facilitate communications with the web server. For example, the operating system may operate to display a graphical user interface to the user and permit the user to execute other computer programs, such as a browser application. The browser application, such as Microsoft Internet Explorer, Mozilla Firefox, when executed by the processor, permits the user to access the World Wide Web as is well known. Similarly, other applications or “apps” on mobile devices may be used. A server, computer, or other network device that may host the workflow tools may have a display which displays a graphical user interface. Any display known in the art may be used including, but not limited to, a cathode ray tube, a liquid crystal display, a plasma screen, a touchscreen, an LED screen, or an OLED display.

Each task within the automated SCP/capacity planning management process may be an individual piece of work that may occur to complete a process. Tasks may be completed by a person, automated, completed automatically through the passage of time or conditioned on additional information. Tasks may also be a combination of timed and some other type, such as “person timed” or “automated timed.”

One or more tasks may occur to a set of workflow rules. The rules may dictate when a user performs one or more steps, or when a machine automatically performs one or more steps. The rules may be based on timing, sequence, results from prior tasks, automatically received information, or inputs from users. The tasks may be executed by a person or by one or more computers. The computers or other network devices may have one or more processors and memory and may include non-transitory and/or tangible computer readable media which may contain instructions, logic, data, or code that may be stored in persistent or temporary memory of the computer or other device, or may somehow affect or initiate action by the computer or other device. All tasks may be conditionally started using selection criteria. In some embodiments, the tasks may be involved with initiating, confirming, scheduling, or executing capacity market operations.

In some embodiments, the workflow rules may be predefined or defined to follow regulations. In some embodiments, workflow tools may be provided to or accessed by one or more entities (also referred to as “users” herein) including but not limited to system participants described elsewhere herein. An entity may further define the rules or selection criteria to meet the entity's needs. For example, if multiple companies receive the workflow tools, the workflow may be designed to meet corporate policies. In another example, the regulations may be determined by a governmental body or regulatory authority. The workflow may be designed to meet government or industry standards.

The invention may utilize an object-based representation of the internal software processes to allow for modification of the workflow process after the workflow engine 4 is compiled and installed. Such functionality may preferably reside in the data visualization engine 8. Furthermore, the object-based workflow tools may permit dynamic alterations to the workflow engine 4 such that the entire workflow process may be re-ordered or the steps rearranged without restarting system components or reinstalling the workflow engine. In one example, by simply clicking on a visual representation of a task in the window and dragging the object on the screen, a task may be removed and reinserted into the workflow. Connection arrows may be deleted and reinserted to reorder the workflow process. A graphical user interface may be provided that may allow a user to add one or more tasks, remove one or more tasks, or move one or more tasks within the workflow process. Connection arrows may be added, removed, and/or moved in the workflow process. Such actions may occur by use of any interactive device which may include, but is not limited to, a keyboard, mouse, trackball, stick, remote, touchscreen, or touchpad.

The visual representation of the tasks may be visually mapped according to a sequence or according to time. In one example, tasks that may occur later in time or sequence may be located toward one end of the display and tasks that may occur earlier in time may be displayed toward the other end of the display. For example, a task that may occur earlier in time or sequence may be at the left of a display and a task that occurs later in time or sequence may be at the right of a display. In another example, a task that may occur earlier in time or sequence may be at the top of a display and a task that occurs later in time or sequence may be at the bottom of a display. In other examples, the location of the visual representation of the task on the display need not have a relationship with the timing or sequence of the task. A connection arrow or other connecting representation may indicate the order of tasks. In some embodiments, the connector may indicate a relationship between the tasks (e.g. whether they have a conditional relationship or not, or whether information is provided from one task to another).

The workflow process may be preconfigured or have a default setting. In some embodiments, the default setting may be the same for all entities. In other embodiments, the default setting may vary between the entities. The default settings may be set according to each entity's preferences. A user may modify the workflow process. In some embodiments, the user may only modify certain parts of the workflow process, or may only modify the workflow process to fit within preset specifications. The default settings or any modifications to the settings may be stored in memory on the one or more web servers, on a device hosting the workflow tools and/or on one or more devices hosting the workflow, risk mitigation, real-time analytics and/or data visualization engines.

The workflow engine 4 may collect information, such as capacity availability, bids, capacity supply/demand, mitigation paths etc., and details, such as unit substitutions, outages, de-rates etc., associated with SCP/capacity planning. The workflow engine and/or the workflow tools may provide a list of bid or mitigation requests and/or may prioritize these requests. The workflow engine and/or the workflow tools may schedule bidding transactions, capacity deployment, capacity substitutions aligned with financial incentives/charges and/or settlements or adjust timing of these tasks. In some embodiments, any user interface may assist with scheduling of these tasks.

The workflow engine 4 may use selection criteria to evaluate all SCP mitigation, capacity bidding and/or capacity planning requests and may render decisions as to whether or not to start a task. All tasks may be completed in a sequence defined by a checklist. Roles, performers, operators and other entities may be defined using the workflow tools.

One or more customers may interact with the automated SCP/capacity planning management system. In some embodiments, the one or more customers may optionally design rules for workflow and/or interact with the workflow tools of the automated SCP/capacity planning management system. The one or more customers may provide availability, scheduling, unit substitution, supply/demand outlook, outage/de-rate and/or other information. The one or more customers may further make requests, such as risk mitigation requests, capacity offers in response to capacity shortages, capacity bids, pre-qualification requests and/or scheduling requests. For example, the customer may provide information requesting a unit to be pre-qualified such that if/when a unit substitution is required, capacity can be substituted in order to meet maintain SCP value without further need for approval.

The one or more customer account dashboards 2 may be reporting interfaces that may report on the periodic and/or real-time status of capacity markets, including but not limited to SCP for the customer's resource, scheduling and capacity supply/demand. The one or more customer account dashboards 2 may also report on requests, notifications and transactions in the system. The customer account dashboard may provide a graphical user interface that may be shown in a display of a device. In some embodiments, the customer account dashboard may be hosted by and/or displayed on the same computer or network device as one or more other components in the system. For example, the customer account dashboard may be hosted on the web server 3. The customer account dashboard may be hosted by and/or displayed on the same computer or network device as one or more of the engines 4, 6, 7, 8 or a different computer or network device than said engines. Alternatively, the customer account dashboard may be hosted by and/or displayed on a different computer or network device than one or more other components in the system.

The one or more web servers 3 may accept and send information to be displayed. In some embodiments, the one or more web servers may receive configuration and information instructions for the workflow engine. The one or more web servers may communicate with the one or more customer account dashboards which may display SCP/capacity planning information. The one or more web servers may communicate with one or more devices hosting the one or more customer account dashboards through a network. Any of the connections previously described may be used to permit communication between the one or more web servers and the one or more devices.

In some embodiments, the displayed information may include spot price, quantity, deadlines, severity etc. The information may be displayed as values and/or graphs. The one or more customer account dashboards may indicate whether requests have been approved or not, associated scheduling, proposed mitigation paths and/or incentive opportunities, power generation/outage status, resource capacity availability, capacity supply/demand, resource SCP etc.

A grid operator 5 may have an electronic system managed by the grid operator to receive and respond to requests. Alternatively, the system may provide a management interface to the grid operator. In some embodiments, a workflow engine 4 may send buy/sell/trade and/or other request to the grid operator via the one or more servers 1. The request may include details about available or non-available RA capacity, details about substitute capacity, outage/de-rate information, magnitude of capacity flows, timing of transfers, proposed mitigation path and/or settlements, capacity market price and so on. The grid operator may provide a response. The response may be acceptance of a request. An acceptance may also comprise implementation of a capacity operation on the electricity grid. In some instances the response may be denial of the request. The grid operator may be obliged to implement some requests. In some instances, the grid operator may provide feedback confirming that a capacity operation was executed. The grid operator may also have the authority to override some requests and/or interfere with the automated SCP/capacity planning management system. Further, the workflow engine 4 may provide a start signal to the grid operator 5 via the one or more servers 1. In some embodiments, the start signal may cause the grid operator to start a capacity operation on the electricity grid. In some embodiments, the start signal may be provided if the grid operator previously provided an acceptance of a request. In other embodiments, the start signal may be timed.

One or more of the workflow engine 4, risk mitigation engine 6, real-time analytics engine 7, data visualization engine 8, web servers 1, 3 and/or the management interfaces may be in communication with one or more email clients (not shown) in accordance with some embodiments of the invention. The email client may be a standard email client or any email client known in the art, where the user can get notification messages from the workflow engine and may initiate or respond to workflow action requests per workflow rules. In other embodiment, such user interactions may occur through a computer, mobile device, or any other network device and may or may not involve an email client. These devices may or may not host other components of the present system.

In some embodiments, the automated management system may be in communication with one or more sensors that may provide input that may be incorporated into system processing. One example of such a sensor may include a utility meter. The utility meter may indicate generation status, level, or trends. The utility meter may provide an indication of availability. The automated management system may directly communicate with utility meters, monitoring generation data processing gateways, or meter data management systems on a preconfigured interval or as directed by user parameters. Such data may be collected, processed and delivered to relevant parties. For example, a user may input a planned or predicted outage, and a utility meter may indicate an unplanned outage. The automated SCP/capacity planning management system may also communicate with one or more sensors by proxy. For example, outage information may be provided to a grid operator, wherein the grid operator, being a user, may supply information to the system.

One or more steps performed by the engines 4, 6, 7, 8, the web servers 1, 3 and/or the management interfaces 5, 2 may be through the aid of one or more processors and a memory. Each system component may comprise one or more processors and/or one or more physical memory locations. Alternatively, processors may be shared by one or more system components, or may be provided externally. In some cases, one or more system components may share a memory location. The memory location may be provided internally to the management system in FIG. 2, externally to the management system in FIG. 2 or a combination thereof.

In accordance with a further aspect of the invention, a method for automated SCP/capacity planning management is provided. The method may provide instant and electronic calculation of estimated performance incentives and non-availability charges for SCP. The method may further provide automation of selling, buying and trading capacity to meet electricity market RA requirements.

The method may comprise providing a management system in accordance with another aspect of the invention. Users may interact with the system to provide information, receive information or notifications, submit requests, receive requests and/or submit responses. Further information may be provided by other system participants, including, for example, various sensors. The system may optimize, schedule or otherwise process such user exchange to provide management tasks and to initiate further user exchange. User exchange may involve one or more transactions, such as, for example, accepting a request, that may change the overall state of the electricity grid.

Preferably, the method may provide management and timely settlement of financial incentives or charges for SCP. This may involve notifying users of financial incentives or charges for SCP, proposing or requesting user action, processing user action and updating the state of the SCP/capacity planning management information system and/or other tasks.

The method may further provide management of selling, buying and trading capacity. This may involve notifying users of electricity grid status, such as capacity supply and demand, electricity spot price and other metrics, allowing users to place and accept bids and implementing transactions following necessary user input. The method may involve scheduling capacity. The management system may transact some operations automatically without requiring user input. Further, operations may be implemented on the electricity grid by a grid operator.

In preferable embodiments of the invention, the automated SCP/capacity planning management process may include performing one or more tasks in accordance with workflow rules. The tasks may be performed sequentially. Alternatively one or more tasks may be performed in parallel. Tasks may be performed in any combination of sequentially or in parallel. Further, any of the steps may be optional or may be provided in any order. Additional steps may be provided or similar steps may be substituted. In some embodiments, workflow rules may be input to the automated SCP/capacity planning management system by a user. The workflow rules input may include adding, removing, or modifying an existing task in the SCP/capacity planning management process.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. An automated SCP/capacity planning management system comprising:
one or more management interfaces hosted on one or more devices with a display, wherein the one or more management interfaces are configured to accept input from one or more users via a graphical interface shown on the display; and
one or more engines in communication with the one or more management interfaces over a network, wherein the one or more engines are configured to process, with the aid of one or more processors and a memory, the input from one or more users in accordance with one or more workflow rules and algorithms, and wherein the one or more engines are configured to communicate SCP/capacity planning related information with the one or more management interfaces.

2. The system of claim 1, wherein the input from one or more users alters one or more of the workflow rules.

3. The system of claim 1, wherein the input from one or more users includes at least one of the following: information about capacity availability, information about resource outage, de-rate, pre-qualification or substitution, request for or response to financial incentives or charges for SCP, or capacity bids.

4. The system of claim 1, wherein the SCP/capacity planning related information includes one or more of the following: capacity availability standard, capacity market price, capacity supply, transmission and demand, outage information, capacity scheduling, capacity bidding information, or financial incentives or charges for SCP.

5. The system of claim 1, wherein the workflow rules follow one or more regulations.

6. The system of claim 1, wherein the workflow rules are predefined.

7. The system of claim 1, wherein the device is a mobile device.

8. The system of claim 1, wherein the users include a grid operator and one or more customers.

9. The system of claim 1, further comprising an email client configured to generate SCP/capacity planning related notification messages based on information received from the one or more engines.

10. The system of claim 1, wherein the network further comprises one or more web servers.

11. The system of claim 1, wherein the engines include one or more of the following: a workflow engine, a risk mitigation engine, a real-time analytics engine, or a data visualization engine.

12. The system of claim 11, further comprising object-based workflow tools.

13. The system of claim 12, wherein the object-based workflow tools permit dynamic alterations to the workflow.

14. The system of claim 1, further comprising one or more sensors.

15. A method for automated SCP/capacity planning management, said method comprising:
providing a management system comprising one or more processors and a memory, wherein the management system is configured to store one or more SCP/capacity planning tasks within the memory;
accepting, at the management system, a user request or response input and SCP/capacity planning information; and
providing, from the management system, one or more SCP/capacity planning notifications or requests, wherein said notifications or requests are generated using the one or more processors of the management system based on the user request or response input and SCP/capacity planning information in accordance with one or more workflow rules.

16. The method of claim 15, wherein the user request or response input and the notifications or requests provide management and settlement of financial incentives or charges for SCP.

17. The method of claim 15, wherein the user request or response input and the notifications or requests provide management of selling, buying and trading capacity.

18. The method of claim 15, wherein the SCP/capacity planning information is provided by at least one of the following: a grid operator, a customer, or a sensor.

19. The method of claim 15, wherein the one or more SCP/capacity planning notifications or requests are received by at least one of the following: a grid operator, or a customer.

20. The method of claim 15, further comprising communicating information, inputs, requests and/or notifications between the management system and one or more management interfaces.
